(19) United States
(12) Patent Application Publication
(10) Pub. No.: US 2004/0252264 A1
(43) Pub. Date: Dec. 16, 2004

(54) Polarizer having retarder and liquid crystal display apparatus comprising the same

(75) Inventor: Akiko Shimizu, Niihama-shi (JP)

Correspondence Address: SUGHRUE MION, PLLC, 2100 PENNSYLVANIA AVENUE, N.W., SUITE 800, WASHINGTON, DC, 20037, US

(73) Assignee: SUMITOMO CHEMICAL COMPANY, LIMITED

(21) Appl. No.: 10/809,482

(22) Filed: Mar. 26, 2004

(30) Foreign Application Priority Data
Mar. 28, 2003 (JP) 2003-090260

(51) Int. Cl. G02F 1/1335

(52) U.S. Cl. 349/117

(57) ABSTRACT

The present invention provides a polarizer having retarder, which has excellent uniformity and biaxial orientation as a whole, further capable of setting a wide range of optical characteristics of biaxial orientation, and provides a liquid crystal apparatus, to which the polarizer having retarder is applied. The polarizer having retarder comprises a polarizing film; and a phase retarder, which includes a substrate of a transparent film and at least one coat layer with birefringent anisotropy being on at least one surface of the substrate. The in-plane retardation value (R₀) of the retarder is not less than 20 nm, and the retardation value along the thickness direction (R′) calculated based on the retardation value (R₄₀) measured by inclining by 40° around the slow axis in the plane and the in-plane retardation value (R₀) is more than 40 nm. The liquid crystal apparatus includes the polarizer having retarder combined with a liquid crystal cell.

### BACKGROUND OF THE INVENTION

1. Technical Field

The present invention relates a polarizer having retarder effective for improving viewing angles to a liquid crystal display apparatus. Additionally, the present invention also relates to a liquid crystal display apparatus comprising the polarizer having retarder.

2. Description of Related Art

A liquid crystal display apparatus (hereinafter, sometimes referred to as an “LCD”) has been widely used as a flat display apparatus from a small size to a large size. However, LCD has such viewing angels characteristics that, in view at an oblique angle, the contrast of display become low or gradation reversion, which means to reverse brightness in gradation displaying, occurs. Accordingly, it has been strongly desired to improve these charcteristics.

Recently, a vertically aligned nematic type liquid crystal display apparatus (VA-LCD) disclosed in Japanese Patent No. 2548979 has been developed as an LCD system for improving viewing angles characteristics. As described in SID 97 DIGEST page 845-848, it is possible for the VA-LCD to obtain characteristics of wide viewing angles that two negative uniaxial retarders with an optical axis in the direction perpendicular to the film plane are provided on both the upper and lower surfaces of a liquid crystal cell. In addition, it is also known that applying a uniaxial phase retarder with positive birefringent anisotropy, the in-plane retardation value of which is approximately 50 nm, to this LCD can achieve further wide viewing angles characteristics. Such a retarder, where the two negative uniaxial retarder with an optical axis in the direction perpendicular to the film plane is combined with the uniaxial retarder with positive birefringent anisotropy, has similar optical characteristics to biaxially oriented retarder as a whole.

In addition, it is also known as a method for improving viewing angles characteristics other than the VA-LCD that a biaxially oriented retarder is applied to a 90° twist nematic liquid crystal display apparatus. Accordingly, a biaxially oriented retarder with a simple construction and with enough uniformity of retardation value or of direction of slow axis applicable for an LCD is required.

It is known that a biaxially oriented retarder can be obtained by biaxially stretching a film consisting of a thermoplastic polymer. An experimental apparatus for biaxially stretching a small piece of film and a continuous biaxially-stretching apparatus conventionally used for manufacturing a wrapping film or the like are already known as an apparatus for biaxially stretching. However, such an experimental apparatus cannot produce a retarder with an enough large size applicable for an LCD in quantity. On the other hand, it is difficult for such a continuous biaxially-stretching apparatus to achieve uniformity of retardation value, uniformity of direction of slow axis, and quality of surface (no scratches) applicable for an LCD in a large area. Additionally, although a conventional stretching apparatus for producing a retarder for an LCD can obtain enough uniformity in a large area, the obtained optical characteristics only has a extremely limited range of biaxial orientation.

It is also known that some kinds of coating solutions form a layer with birefringent anisotropy. For example, U.S. Pat. No. 6,060,183 discloses that a retarder is formed of a layer including at least one kind of organically modified clay compound dispersible in an organic solvent. WO94/24191 discloses that a homopolymer film prepared from a polyimde solution is used as a negative birefringence layer of an LCD. WO96/11967 discloses that a negative birefringence film prepared from a rigid rod polymer consisting of polyamide, polyester, poly(amide-imide), or poly(ester-imide) with negative birefringent anisotropy is used for an LCD. In addition, U.S. Pat. No. 5,196,953 discloses that a multi-layer thin film, where materials with deferent refractive indexes are alternatively laminated, is use as an optical compensating layer.

On the other hand, in the case that a conventional biaxially oriented retarder is used for an LCD, it is usually necessary to laminate a polarizer with protect layers, which are transparent resin films attached to both surfaces of a polarizing film, on the retarder. This results in making an LCD thicker and increasing its cost.

The inventors have intensively studied in order to develop a retarder with excellent uniformity even in an LCD with a large area and with wide range of optical characteristics and further to develop a polarizer having retarder and a polarizing film comprising the polarizer. As a result, the inventors found that it was possible to achieve necessary optical characteristics by developing a laminated retarder, which comprises a substrate of a transparent film and at least one coat layer with birefringent anisotropy laminated on at least one surface of the substrate, wherein the in-plane retardation value (R₀) of the laminated retarder is in a specific range, and the retardation value in the thickness direction (R′) calculated based on the retardation value (R₄₀) measured by inclining by 40° around the slow axis in the plane and the in-plane retardation value (R₀) is in a specific range. In addition, the inventors found that integrating this laminated retarder on a polarizing film can provide a polarizer film having retarder capable of using as a viewing angle compensating film with low cost, and completed this invention.

Therefore, the present invention provides a polarizer having retarder, which has excellent uniformity and biaxial orientation as a whole, further capable of setting a wide range of optical characteristics of biaxial orientation. Further, the present invention provides a polarizer having retarder capable of obtaining uniform optical characteristics even in a large area. Additionally, the present invention provides a liquid crystal display apparatus with improved viewing angles, thin thickness, and low cost by using the polarizer having the retarder.

### SUMMARY OF THE INVENTION

The present invention provides a polarizer having retarder comprising a polarizing film and a retarder which comprises a substrate of a transparent film and at least one coat layer with birefringent anisotropy on at least one side of the substrate, wherein the in-plane retardation value (R₀) of the retarder is not less than 20 nm, and the retardation value (R₄₀) calculated by inclining by 40° around the slow axis in the plane and the retardation value in the thickness direction (R′) calculated based on the in-plane retardation value (R₀) is more than 40 nm, and wherein the retarder is on at least one side of the polarizing film.

In the above polarizer having retarder, the coat layer with birefringent anisotropy may comprise a liquid crystal composition or a composition cured from a liquid crystal composition. In addition, the coat layer with birefringent anisotropy may also comprise a layer including an organically modified clay which is dispersible in organic solvents. Additionally, the coat layer with birefringent anisotropy may also comprise homopolymer of imides prepared from a solution of polyimide, or a layer including a rigid rod polymer with negative birefringent anisotropy selected from the group consisting of polyamide, polyester, poly(amide-imide), poly(ester-imide). Furthermore, the coat layer with birefringent anisotropy may also comprise a multi-thin-layer where materials with different refractive indexes are alternatively laminated.

The above the polarizer having retarder is effectively used for improving various modes of viewing angles characteristics in an LCD such as vertically alignment (VA), twist nematic (TN), or optically compensated birefringent (OCB). Therefore, the present invention also provides a liquid crystal display apparatus with at least one polarizer having retarder mentioned above, and a liquid crystal cell.

### DETAILED DESCRIPTION OF THE PREFERRED EMBODIMENTS

The following description will describe the present invention. In the present invention, a polarizer—having retarder comprises a retarder, which has a specific layer-construction and specific optical characteristics and is on at least one surface of a polarizing film. The polarizing film can be a polarizing film with selective transparent for a specific vibration direction of linear polarized light. For example, a polarizing film, in which dichroic matter is orientated in a polyvinyl alcohols film, can be used. Typically, iodine or dichromatic dye can be used as the dichroic matter. For example, a polarizing film where an iodine molecule is absorption-orientated in uniaxially stretched polyvinyl alcohol, or a polarizer where azo group dichromatic dye is absorption-orientated in uniaxially stretched polyvinyl alcohol can be used as the polarizing film. Such a polyvinyl alcohol polarizing film where dichroic matter is absorption-orientated absorbs linear polarized light with a vibration plane in the orientation direction of the dichroic matter, and passes linear polarized light with a vibration plane in the direction perpendicular to it.

In the polarizer having retarder according to the present invention, it is preferable that a transparent film used as a substrate of the retarder has orientation in the plane, and it is preferable that its in-plane retardation value (referred to as R_{0B}) is not less than 20 nm. In addition, in order to effectively compensate viewing angles of a VA-LCD, or a twisted nematic liquid crystal display apparatus driven by a thin-film transistor (TFT-TN-LCD), the in-plane retardation value (R_{0B}) of the substrate may be required within the range of 20-160 nm, or within the range of 250-300 nm, approximately a half of a wavelength of visible light.

The transparent substrate includes a film of polycarbonates, cyclic polyolefins, celluloses, and so on. In the case where the polarizer having retarder according to the present invention is used as a viewing angle compensating film for a large-size LCD with a 14-inch (355 mm) diagonal screen, when the polarizer having retarder attached to a liquid crystal cell with an adhesive agent is used at high temperature, retardation value may be deviated due to the stress caused by heat. In addition, in the case of a translucent type LCD, nonuniform retardation values may be generated by nonuniform stress caused by heat of backlight. Such deviation or nonuniformity causes low contrast or nonuniform display. When the polarizer having retarder is used under such stress, in order to prevent deterioration of uniformity of retardation value, modified polycarbonates or polycarbonate copolymers, a cyclic polyolefins, celluloses, and so on, which have an absolute value of photoelasticity coefficient of not more than 10×10⁻¹³ cm²/dyne is preferably used as the transparent resin of the substrate.

A preferable method for producing the transparent film includes, for example, a method of stretching a film, which is formed by a solvent casting method, a precision extrusion method with low residual stress, or the like, so that the transparent film having required optical characteristics. A preferable production method of the film includes a method of solvent casting. In the solvent casting method, first, the resin mentioned above dissolves in appropriate solvents, and the solution casts and extends on a belt, drum of stainless steel, or on a releasing film such as a poly(ethylene terephthalate) film subjected to releasing treatment, and then dried it, to produce a film by releasing from the belt, the drum, or the releasing film. Accordingly, a film with excellent uniformity can be obtained.

A method for stretching the film includes a method of transverse uniaxially stretching method by a tenter, an inter-rolls longitudinal uniaxially stretching method of low magnification, or a method for uniaxially stretching the film in the film flow direction with slight stress in a process for releasing the film from the belt, the drum or the releasing film, or in a drying process during the solvent casting method. When a required in-plane retardation value (R₀) of the retarder in the polarizer having retarder is not less than 100 nm, it is preferable that the film is orientated by a method of transverse uniaxially stretching by a tenter or an inter-rolls longitudinal uniaxially stretching method. On the other hand, when a required value R₀ is approximately 20-100 nm, a method for uniaxially stretching the film in a solvent casting process or a winding process after an extruding process of the film is preferably used. The degree of orientation by stretching is performed so as to obtain a required retardation value in the film plane (R_{0B}), and is not specifically limited. The orientation may be uniaxial orientation, or biaxial orientation, which is obtained by a method of transverse uniaxially stretching by tenter.

The retarder in the polarizer having retarder according to the present invention is obtained by laminating coat layers with birefringent anisotropy on or above a transparent film as mentioned above, and has biaxial orientation as a whole. In the preferred embodiment, the transparent film as a base material has a difference of the in-plane retardation, and the coat layers with negative birefringent anisotropy along the thickness direction is laminated so as to compensate lack of biaxial orientation, therefore the polarizer having retarder has biaxial orientation as a whole.

A layer with negative birefringent anisotropy along the thickness direction may be used as the coat layer with birefringent anisotropy. For example, the following materials may include;

a layer including a liquid crystal composition or a composition cured from a liquid crystal composition,

a layer including at least one organically modified clay compound dispersible in organic solvents, such as a composition disclosed in U.S. Pat. No. 6,060,183, which is incorporated herein,

a layer of homopolymer of polyimide prepared from a polyimide solution, such as a layer disclosed in WO94/24191, which is incorporated herein,

a layer including a rigid rod polymer composed of polyamide, polyester, poly(amide-imide), or poly(ester-imide), where these polymers have negative birefringent anisotropy, such as a layer disclosed in WO96/11967, which is incorporated herein,

a layer composed of a multi-thin-layer where materials with deferent refractive indexes are alternatively laminated, such as a layer disclosed in U.S. Pat. No. 5,196,953, which is incorporated herein, and so on.

When a layer including a liquid crystal composition or a composition cured from a liquid crystal composition is used as a coat layer, it is necessary to make the liquid crystal composition orient so that the coat layer has negative birefringent anisotropy along the thickness direction. The morphology of orientation depends on the type of liquid crystal composition. For example, homeotropic alignment where a disc plane is oriented upwardly is preferable when a discotic liquid crystal composition is used, and, a super twisted alignment with twist of not less than 270° is preferable when a rod-like nematic liquid crystal composition is used, from the viewpoint where the layer has negative birefringent anisotropy along the thickness direction. Additionally, it is possible to obtain required optical characteristics by laminating a liquid crystal layer with homeotropic alignment or hybrid alignment where a direction of a slow axis in the plane is perpendicular to a slow axis of birefringent anisotropy in the plane of the transparent resin film used as the substrate. A method for orienting a liquid crystal composition is not specifically limited and includes, a typical method such as usage of orientated film, rubbing, addition of chiral dopant, or light irradiation can, for example. Further, a liquid crystal composition may be cured after the liquid crystal composition is oriented in order to fix the orientation, or the mesomorphism can remain so as to provide temperature compensation or the like.

In the case that a layer including at least one organically modified clay compound dispersible in organic solvents, such as a composition disclosed in U.S. Pat. No. 6,060,184 is used as the coat layer, when the substrate is formed in a flat sheet, the layer structure of a single crystal layer of the organically modified clay compound is oriented in parallel to the plane of the flat sheet, and its orientation in the plane is randomly orientated. Accordingly, it is possible to obtain a structure with a higher refractive index in the film plane than the refractive index along the film thickness direction without a specific orientation treatment.

The organically modified clay is a composite material of an organic compound and a clay mineral as disclosed in U.S. Pat. No. 6,060,183, for example, the organically modified clay can be an organically modified clay by compounding a clay mineral having a layer structure and an organic compound. A clay mineral having a layer structure includes a smectite group or swellable mica, and the clay can be compounded with an organic compound by its cation exchangeability. The smectite group is preferably used in the viewpoint of its excellent transparency. The smectite group includes hectorite, montmorillonite, bentonite and their substituted compounds, derivatives and mixtures thereof. Among these, a clay prepared by chemical synthesis is preferably used for the phase retarder from the viewpoint of its low content of impurities and its superiority in transparency. Synthetic hectorite whose particle diameter is controlled to small is preferably used from the viewpoint where scattering of visible light is suppressed.

A compound capable of reacting with the oxygen atoms or hydroxyl groups of the clay mineral, or ionic compound capable of exchanging with the exchangeable cation of the clay mineral can be used as the organic compound which is compounded with the clay mineral. It is not specifically limited as long as it allows the organically modified clay compound to swell or disperse in the organic solvent, and a compound containing nitrogen is preferably used. The compound containing nitrogen includes a primary, secondary, tertiary, or quaternary ammonium compound, urea, hydrazine, and so on. Particularly, it is preferable to use a quaternary ammonium compound from the viewpoint of easily exchanging cation.

A composite material of synthetic hectorite and a quaternary ammonium compound of trade name “Lucentite STN”, “Lucentite SPN” manufactured by Co-op Chemical Co., Ltd., respectively, and so on, can be used as an organically modified clay available in the market.

Such an organic clay compound dispersible in an organic solvent is preferably used with a hydrophobic resin from the viewpoint of ease of forming the coat layer on or above the substrate, the appearance of optical characteristics, mechanical characteristics, and so on. A resin dispersible in an organic solvent with low polarity such as benzene, toluene, xylene is preferably used as the hydrophobic resin. In addition, in order to obtain preferable resistance to moisture and heat, and ease of handling when the polarizer having retarder is applied for a large-size liquid crystal apparatus with not less than 15-inch (381 mm) diagonal screen, a resin having strongly hydrophobic and strong adhesibility to the transparent resin substrate is preferable. A preferable hydrophobic resin includes, a polyvinyl acetal such as polyvinyl butyral, polyvinyl formal; a cellulose resin such as cellulose acetate butyrate; an acrylics resin; a meta-acrylics resin; and so on, particularly, a butyl acrylate group resin and a dicyclopentanyl acrylate group resin are preferable. The rein may be previously polymerized, or may be polymerized with monomer or oligomer by a method such as heat curing or ultraviolet ray curing in a process of a layer forming. In addition, two or more kinds of the resin may be used together.

A hydrophobic resin includes an aldehyde modified resin of the polyvinyl alcohol of trade name “Denka Butyral #3000-K”, manufactured by Denki Kagaku Kogyo Co., Ltd., an acrylics resin, which mainly contains butyl acrylate, of trade name “Aron S1601” manufactured by Toagosei Co., Ltd., a meta-acrylics group resin, which mainly contains dicyclopentanyl acrylat, of trade name “Banaresin MKV-115” manufactured by Shin-Nakamura Chemical Co., Ltd., and so on.

From the viewpoint of improving mechanical characteristics so as to prevent a crack of a layer including the organically modified clay and the hydrophobic resin, the preferable ratio of the organically modified clay dispersible in organic solvents and the hydrophobic resin is from 1:2 to 10:1 as the weight ratio of the former: the later. The organically modified clay dispersed in organic solvents is applied onto the substrate of a transparent film. When the hydrophobic resin is used together, the hydrophobic resin disperses or dissolves in the organic solvent. The concentration of total solid components of the organically modified clay and the hydrophobic resin is usually from 3 to 15% by weight, however, the concentration of solid components in the dispersion liquid is not limited as long as the prepared dispersion liquid does not gelate nor become clouded within several days. Since the most suitable concentration of the solid components depends on the kind of and the composition ratio of the organically modified clay and the hydrophobic resin, it is determined according to each composition. In addition, various addition agents such as a viscosity adjusting agent for improving application characteristics in a process forming a film on the substrate, and a cross-linking agent for further improving hydrophobic characteristics and/or durability may be added.

A layer of homopolymer of polyimide prepared from a polyimide solution, such as a layer disclosed in WO 94/24191, or a layer including a rigid rod polymer consisting of polyamide, polyester, poly(amide-imide), or poly(ester-imide) with negative birefringent anisotropy, such as a layer disclosed in WO 96/11967 can be used as the coat layer. The main chain of these kinds of soluble polymer is aligned in parallel to the surface of the substrate film after self-orienting process by a method of casting the soluble polymer on the substrate film and these kinds of soluble polymer show negative birefringent anisotropy. Therefore, the degree of negative birefringent anisotropy can be adjusted by changing not only the coat layer thickness but also characteristics of main chain line or stiffness of main chain.

When a layer composed of a multi-thin-layer where materials with deferent refractive indexes are alternatively laminated, such as a layer disclosed in U.S. Pat. No. 5,196,953 is used as the coat layer, the thickness and the refractive index of each layer can be designed in order to obtain required negative birefringent anisotropy according to this U.S. patent.

In the present invention, the coat layer with birefringent anisotropy laminated on the substrate of transparent film as mentioned above is used as the portion of the retarder of the polarizer having retarder, and an anchor coat layer may be provided on the transparent substrate, or surface treating may be conducted on the surface of the transparent substrate from the viewpoint of further improving intimate contact between the coat layer with birefringent anisotropy and the transparent substrate. A resin used for an anchor coat layer is not limited as long as the coat layer with birefringent anisotropy can be uniformly applied on the anchor coat layer which is provided on the substrate and the anchor coat layer can improve the intimate contact between them. A resin used for an anchor coat includes Urethane resins, acrylics resins, meta-acrylic resins, and so on. The surface treatment is not also limited as long as the coat layer with birefringent anisotropy can be uniformly applied on the substrate and the intimate contact between the coat layer and the substrate can be improved. The surface treatment includes corona treatment or the like.

The method for forming the coat layer with birefringent anisotropy on the transparent resin substrate, and if an anchor coat layer is provided, the method for forming the anchor coat layer on the transparent resin substrate are not limited. Various known coating methods such as a direct gravure method, a reverse gravure method, a die coating method, a comma coating method, a bar coating method can be used. Particularly, a comma coating method, and a die coating method, which does not use a backup roll, and so on, are preferably used because they have high-precision of thickness.

The thickness of the coat layer is not limited as long as the required optical characteristics, particularly biaxial characteristics can be achieved, by being combined with the optical characteristics of the transparent film as the substrate as a whole of the portion of the retarder of the polarizer having retarder. In other words, the thickness of the coat layer may be selected so as to have optical characteristics to compensate the difference between optical characteristics of the total optical characteristics required for the retarder and the optical characteristics of transparent film.

The biaxial characteristics and the birefringent anisotropy along the thickness direction required for the portion of the retarder of the polarizer having retarder depend on its application. The biaxial characteristics and the birefringent anisotropy are represented by the retardation value along the thickness direction (R′) defined by the following formula (I). As mentioned later, this value is calculated based on the retardation value (R₄₀) measured by inclining by 40° around the slow axis in the plane and the in-plane retardation value (R₀).

R′=[((nₓ+n_{y})/2)−n_{z}]×d (I)

where nₓ is the refractive index of the slow axis direction in the film plane, n_{y} is the refractive index of the direction perpendicular to nₓ in the film plane, n_{z} is the refractive index along the thickness direction, and d is film thickness.

For example, the in-plane retardation value (R₀) of the portion of the retarder of the polarizer having retarder can be within the range approximately 20-300 nm, and the retardation value along the thickness direction (R′) can fall within the range of approximately 20-1200 nm. It is preferable that the retardation value along the thickness direction (R′) is approximately 50-300 nm. In more detail, in order to effectively compensate viewing angles of a VA-LCD, or a TFT-TN-LCD, it is preferable that the in-plane retardation value (R₀) of the retarder of the polarizer having retarder is 20-160 nm, or 250-300 nm which is approximately a half of a wavelength of visible light. When the in-plane retardation value (R₀) of the retarder is 20-160 nm, it is preferable that the retardation value along the thickness direction (R′) is 50-300 nm. In addition, the preferable coefficient N_{z} defined by (nₓ−n_{z})/(nₓ−n_{y}) (representing the balance between R₀ and R′) is greater than 3, since it may be effectively improve viewing angles of a VA-LCD, or a TFT-TN-LCD. On the other hand, when the above in-plane retardation value (R₀) of the retarder is 250-300 nm which is approximately a half of a wavelength of visible light, it is preferable that the retardation value along the thickness direction (R′) is 500-1200 nm.

In the present invention, the retarder, which is produced by laminating the coat layer with birefringent anisotropy on the transparent film as mentioned above, is attached to the polarizer which includes, for example, polarizing of polyvinyl alcohols, as mentioned above, to produce the polarizer having retarder. Since the polarizing film of a polyvinyl alcohols as mentioned above is inferior in durability, a polarizer is usually covered with protect layers, for example, is covered both surfaces of the transparent film. However, in the present invention, the retarder is directly attached to the polarizing film through an adhesive layer, therefore the protect layer on the side attached by the retarder is omitted. Accordingly, the polarizer obtained film having retarder results in thin. In this case, a water-solution adhesive agent such as a polyvinyl alcohols, or an adhesive agent such as an acrylics may be used as the adhesive layer.

In lamination of the polarizing film and the retarder, the polarizing film can be laminated onto any of the substrate surface and the coat layer surface of the retarder. The suitable construction can be employed in consideration of ease of attachment between them or viewing angles when it is combined with a liquid crystal cell. For example, in the case that a cellulose resin is used as the substrate film in the retarder, since the substrate side and the polyvinyl alcohol polarizing film can be attached through a water-solution adhesive agent of polyvinyl alcohol, it is advantageous that the thickness of the polarizer having retarder is thin.

When the polarizer having retarder according to the present invention is applied to an LCD, at least one polarizer having retarder is combined with a liquid crystal cell. Typically, this polarizer having retarder is used by laminating on a liquid crystal cell. Generally, the polarizer having retarder is attached so that the side of the retarder faces to the liquid crystal cell, in other words, so that the polarizing film is provided in the remote side from the liquid crystal cell. When the polarizer having retarder according to the present invention is provided in both surfaces of the liquid crystal cell, they may have the same characteristics or different characteristics of the retarder portion.

In addition, the polarizer having retarder according to the present invention may be used with combined with other retarder, or various optical films such as a diffusion film, a reflection film, a transflective film. When this polarizer having retarder is attached to other optical film or a liquid crystal cell, an adhesive agent such as acrylics can be used. The thickness of adhesive agent is usually about from 15 to 30 μm.

### EXAMPLE

The following description will describe the present invention with examples in more detail, however, it should be appreciated that the examples described below are an illustration to give a concrete form to technical ideas of the invention, and the invention is not specifically limited to description below. In the examples, “%” representing contents or amounts to be used is based on weight unless otherwise specified. Materials used for forming coat layer in the examples shown below are as follows.

(A) Organically Modified Clay

Trade Name “Lucentite STN”: A material manufactured by Co-op Chemical Co., Ltd. consists of a compound of synthetic hectorite and quaternary ammonium compound, and has excellent characteristics of dispersion in a solvent with high polarity.

Trade Name “Lucentite SPN”: A material manufactured by Co-op Chemical Co., Ltd. consists of a compound of synthetic hectorite and quaternary ammonium compound, and has excellent characteristics of dispersion in a solvent without polarity.

(B) Hydrophobic Resin

Trade Name “Aron S1601”: A material manufactured by Toagosei Co., Ltd. is an acrylic resin, which mainly contains repeating units derived from butyl acrylate.

Trade Name “Banaresin MKV-115”: A material manufactured by Shin-Nakamura Chemical Co., Ltd. is a meta-acrylic resin, which mainly contains repeating units derived from dicyclopentanyl acrylate.

In addition, methods for physical properties measurement and evaluation of samples are performed as follows.

(1) In-Plane Retardation Value (R₀)

The value is measured with monochromatic light with wavelength of 559 nm by a rotating polarizer method by using “KOBRA-21ADH” manufactured by Oji Scientific Instruments Ltd.

(2) Retardation Value along the Thickness Direction (R′)

nₓ, n_{y}, and n_{z} is obtained by calculation processed by a computer based on the following formulas (II)-(IV) with the in-plane retardation value (R₀), the retardation value measured by inclining by 40° for a slow axis as inclination axis (R₄₀), the film thickness (d), and the average refractive index of film (n₀), and then the retardation value along the thickness direction (R′) is calculated based on formula (I). The in-plane retardation value of the substrate film is R_{0B}, the retardation value in the thickness direction of the substrate film is R′_{B}, the in-plane retardation value of the coat layer is R_{0C}, the retardation value in the thickness direction of the coat layer is R′_{C}, the in-plane retardation value of the retarder as a whole is R₀, and the retardation value in the thickness direction of the retarder as a whole is R′.

R′=[(nₓ+n_{y})/2−n_{z}]×d (I)

R₀=(nₓ−n_{y})×d (II)

R₄₀=(nₓ−n_{y}′)×d/cos(Φ) (III)

(nₓ+n_{y}+n_{z})/3=n₀ (IV)

where

Φ=sin⁻¹[sin(40°)/n₀]

n_{y}′=n_{y}×n_{z}/[n_{y}²×sin²(Φ)+n_{z}²×cos²(Φ)]^{1/2}

### Example 1

A cellulose modified polymer film with thickness of 120 μm was stretched by an inter-roll uniaxially stretching method, and a substrate film with R_{0B}=40 nm, R′_{B}=130 nm was obtained. The surface of the substrate film was subjected to corona treatment under the condition of 70 W/m²/min. A dispersion liquid containing 1.5% of acrylic resin of “Aron S1601”, 1.5% of meta-acrylic resin of “Banaresin MKV-115”, 6.75% of organically modified clay of “Lucentite STN”, 2.25% of organically modified clay of “Lucentite SPN”, 70.4% of toluene, and 17.6% of methylene chloride was continuously applied thereon by a comma coater so that the thickness of a layer after drying was 7.5 μm. Thus, a coat layer with Roc=0 nm, and R′_{C}=80 nm was laminated. The optical characteristics of the obtained retarder was R₀=40 nm, and R′=220 nm.

A protect film of polyethylene terephthalate having an acrylic adhesive agent on one surface was attached onto the coat layer of the retarder through the adhesive agent side. Subsequently, this retarder with the protect film was immersed in 2 N (normality) of potassium hydroxide solution for one minute, and the surface of the side where the protect film was not provided was subjected to saponification treatment, and it was washed for 5 minutes with pure water and then dried. While, a polarizing film was prepared by uniaxially stretching a polyvinyl alcohol film, and by absorbing and orienting iodine. The surface of the substrate of the retarder subjected to the saponification treatment was attached to one surface of this polarizing film of polyvinyl alcohol with an adhesive agent of water solution of polyvinyl alcohol. At this time, a cellulose triacetate film (trade name, “Konica TAC KC80CA” manufactured by Konica, Inc.) subjected to saponification treatment similarly was attached to another surface of the polarizing film with the above same adhesive agent. A polarizer having retarder was then produced.

When the obtained polarizer having phase retarder is attached to a front surface and/or a back surface of a liquid crystal cell through the adhesive agent in the retarder side, an LCD with wide viewing angles is obtained.

According to the present invention, it is possible to easily produce a polarizer having retarder, which has uniformity in large area incapable of being obtained by a conventional method, and biaxial orientation with a wide set range of optical characteristics, accordingly, it is possible to improve of viewing angles of an LCD. Since a predetermined retarder is provided on the surface of a polarizing film in this polarizer having phase retarder, the thickness as a whole can be thin. Therefore, this can allow for an LCD to be thin, and its cost can be lower.

What is claimed is:

1. A polarizer having retarder comprising
a polarizing film; and
a retarder, which comprises a substrate of a transparent resin film and at least one coat layer with birefringent anisotropy being on at least one surface of the substrate, wherein
the in-plane retardation value (R₀) of the phase retarder is not less than 20 nm, and the retardation value along the film thickness direction (R′) calculated based on the retardation value (R₄₀) measured by inclining by 40° around the slow axis in the plane and the in-plane retardation value (R₀) is more than 40 nm.

2. The polarizer having retarder according to claim 1, wherein the substrate of a transparent film has orientation in the film plane, and the in-plane retardation value (R_{0B}) of the substrate is not less than 20 nm.

3. The polarizer having retarder according to claim 1, wherein the substrate of a transparent film is selected from the group consisting of polycarbonate resin, cyclic polyolefin resin, and cellulose resin.

4. The polarizer having retarder according to claim 1, wherein the coat layers with birefringent anisotropy comprises a liquid crystal composition or a composition cured from a liquid crystal composition.

5. The polarizer having retarder according to claim 1, wherein the coat layer with birefringent anisotropy comprises an organically modified clay dispersible in an organic solvent.

6. The polarizer having retarder according to claim 5, wherein the layer comprising an organically modified clay further comprises a hydrophobic resin.

7. The polarizer having retarder according to claim 1, wherein the coat layers with birefringent anisotropy comprises homopolymer of polyimide, or a layer comprising a rigid rod polymer selected from the group consisting of polyamide, polyester, poly(amide-imide), poly(ester-imide), with negative birefringent anisotropy.

8. The polarizer having retarder according to claim 1, wherein the coat layer with birefringent anisotropy comprises a multi-thin-layer.

9. The polarizer having phase retarder according to any of claims 1 to 8, wherein the retarder has the in-plane retardation value (R₀) of from 20 to 300 nm, and the retardation value along the thickness direction (R′) of from 50 to 300 nm calculated based on the retardation value (R₄₀) measured by inclining by 40° around the slow axis in the plane and the in-plane retardation value (R₀).

10. A liquid crystal display apparatus comprising at least one polarizer having retarder according to claim 1, and a liquid crystal cell.
